(19) United States
(12) Patent Application Publication
(10) Pub. No.: US 2026/0351112 A1
(43) Pub. Date: Nov. 5, 2026

(54) FALSE ALARM CLASSIFICATION

(71) Applicant: The ADT Security Corporation, Boca Raton, FL (US)

(72) Inventor: Abhishek NALAMOTHU, Argyle, TX (US)

(21) Appl. No.: 19/194,494

(22) Filed: Apr. 30, 2025

(51) Int. Cl. G08B 29/18; G06V 10/764; G06V 10/774; G06V 20/52; H04N 7/18; H04N 17/00

(52) U.S. Cl. CPC G08B 29/185; G06V 10/764; G06V 10/774; G06V 20/52; H04N 7/183; H04N 17/002

(57) ABSTRACT

Embodiments herein provides a false alarm classification system. The system first receives an alarm triggered by a component within an environment the system monitors. The system then generates one or more event outputs for the environment comprising at least three of: generating a trigger-driven output by processing trigger-driven data using a trigger-driven fault detection model, generating a laser-based output by processing laser-based data using a laser fault detection model, generating an image-based output by processing image-based data using an image fault detection model, or generating a radio frequency (RF)-based output by processing RF-based data using a RF fault detection model. With these outputs, the system compares them with a rule-based table, and generates a likelihood of the alarm being a false alarm based on the comparison.

### TECHNICAL FIELD

Embodiments presented in this disclosure generally relate to security monitoring and, more specifically, to classifying false alarms into a likelihood scale by processing data collected from multiple fault detection systems and comparing the outputs against rule-based tables.

### BACKGROUND

Modern security systems incorporate a wide range of devices to monitor activities and maintain the safety of residential or commercial premises. These devices include entrance alarms, break-in alarms, doorbell cameras, security cameras, motion detectors, and the like. Each sensor type uses distinct technologies to detect specific events or conditions. While these devices are highly effective, they may occasionally generate false alarms, potentially due to environmental changes like lighting or wind, the presence of small animals or pets, or even user or installation errors such as improper sensor placement. Additionally, technological limitations, such as over-sensitive detection thresholds or outdated software, can further contribute to false detections.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a security system, according to some embodiments of the present disclosure.

FIG. 2 illustrates a workflow for training machine learning (ML) models to generate event-based output and implementing the models for real-time predictions, according to some embodiments of the present disclosure.

FIG. 3 illustrates a workflow for training ML models to generate LiDAR-based output and implementing the models for real-time predictions, according to some embodiments of the present disclosure.

FIG. 4 illustrates a workflow for training ML models to generate image-based output and implementing the models for real-time predictions, according to some embodiments of the present disclosure.

FIG. 5 illustrates a workflow for training ML models to generate radio frequency (RF)-based output and implementing the models for real-time predictions, according to some embodiments of the present disclosure.

FIG. 6 illustrates a workflow for false alarm classification using outputs from event-based, laser-based, image-based, and RF-based fault detection systems, according to some embodiments of the present disclosure.

FIG. 7 depicts an example method for processing sensor data to generate fault detection outputs using trained ML models, according to some embodiments of the present disclosure.

FIG. 8 depicts an example method for processing fault detection outputs to generate a final false alarm classification, according to some embodiments of the present disclosure.

FIG. 9 is a flow diagram depicting an example method for false alarm classification, according to some embodiments of the present disclosure.

FIG. 10 depicts an example computing device configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a method that includes receiving an alarm triggered by a component within an environment monitored by a security system. The method also includes generating one or more event outputs for the environment comprising at least three of: generating a trigger-driven output by processing trigger-driven data using a trigger-driven fault detection model, generating a laser-based output by processing laser-based data using a laser fault detection model, generating an image-based output by processing image-based data using an image fault detection model, or generating a radio frequency (RF)-based output by processing RF-based data using a RF fault detection model. The method further includes comparing the one or more event outputs, comprising at least three of the trigger-driven output, the laser-based output, the image-based output, and the RF-based output, with a rule-based table, and generating a likelihood of the alarm being a false alarm based on the comparison.

Other embodiments in this disclosure provide computer-readable media containing computer program code that, when executed by operation of a computer system, performs operations in accordance with one or more of the above methods, as well as systems comprising one or more memories collectively containing one or more programs, and one or more processors, where the one or more processors are configured to, individually or collectively, perform an operation in accordance with one or more of the above methods.

### Example Embodiments

Security monitoring systems utilize a variety of devices and sensors to detect potential threats and protect residential and/or commercial premises from unauthorized access. These security-monitoring devices include door/window entrance alarms, break-in alarms, motion detection sensors, security cameras, doorbell cameras, thermal cameras, LiDAR sensors, ultrasonic sensors, RF detection devices, and the like. Each device is designed with specific technologies to capture different types of security events. For example, door/window entrance alarms may utilize contact sensors or magnetic switches to detect unauthorized openings. Security cameras and/or doorbell cameras may use motion detection and video recording to monitor activity near entrances or within specific areas. LiDAR sensors rely on laser-based technology to map surroundings, track movements, and identify unusual activity. Beacons or Wi-Fi access point (AP) may detect nearby devices or disruptions in RF signals, therefore monitoring for unauthorized wireless devices or potential intrusions. These devices or sensors can provide a comprehensive profile of the monitored environment.

Despite a wide variety of modern technologies, these sensors may still generate false alarms, potentially due to factors such as environmental changes, sensor malfunctions, or improper installation. False alarms may lead to significant challenges. For example, frequent false alarms may reduce the user's trust in the system, leading users to ignore notifications and undermining the effectiveness of the monitoring system. Moreover, false alarms waste valuable time and resources of emergency responders and create unnecessary stress for homeowners, especially when the alarms are triggered repeatedly or during inconvenient times.

Embodiments of the present disclosure address these and other concerns by providing a mechanism to classify and filter out false alarms in the security system. More specifically, in one embodiment, the disclosed system for false alarm classification integrates four different fault detection systems which can work in conjunction to provide a comprehensive profile of the monitored environment. These fault detection systems may include an event-based fault detection system (also referred to in some embodiments as trigger-driven fault detection system), a laser-based fault detection system, an image-based fault detection system, and/or an RF-based fault detection system. Each system may collect data from its respective sensors or devices, process the data using one or more trained ML models, and generate an independent output. These outputs can then be compared against a rules-based table (e.g., a predefined set of rules) to classify false alarms on a likelihood scale. Based on this classification, the system can eliminate (or at least reduce) false alarms while maintaining accurate detection of valid security threats. The disclosed mechanism improves the reliability and effectiveness of the security system.

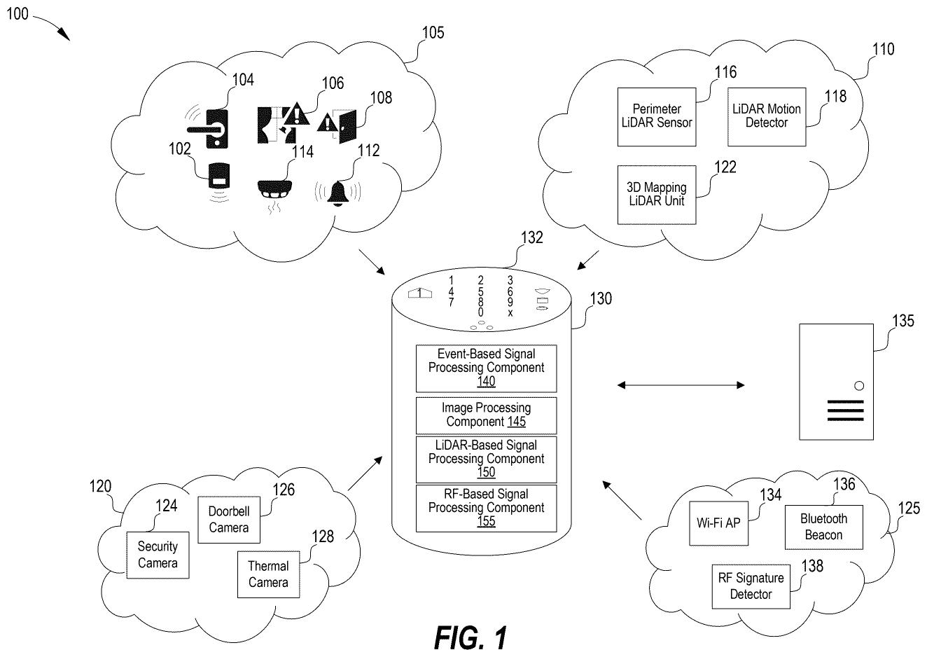

FIG. 1 illustrates a security system 100, according to some embodiments of the present disclosure.

The security system 100 includes a variety of sensors (or devices). These sensors (or devices) are installed in a physical environment (e.g., residential or commercial premises) and may be configured to monitor activities and protect the premises against unauthorized access and/or potential threats. As depicted, the sensors (or devices) are organized into four categories based on the underlying technologies and/or the specific (types of) events monitored: event-based devices 105 (also referred to in some embodiments as trigger-driven, signal-triggered, or input-responsive devices), laser-based devices 110, RF-based devices 125, and image-based devices 120.

As depicted, the event-based devices 105 include door entrance alarms 108, window entrance alarms 106, motion sensors 102, glass break sensors 112, smoke and/or carbon monoxide detectors 114, and smart door locks 104 (e.g., with keypads, fingerprint readers, or card readers). As used herein, event-based devices (also referred to in some embodiments as trigger-driven, signal-triggered, or input-responsive devices) refers to sensors configured to generate a binary signal or discrete output in response to a specific triggering event. The generated signals or alarms indicate the occurrence of a security or safe-related event. A common feature of these devices is that their output may include event codes corresponding to different detected scenarios, allowing the system to distinguish among various event types. For example, in some embodiments, door/window entrance alarms 106 and 108 may use contact sensors and/or magnetic switches to detect unauthorized openings, with different event codes used (e.g., code “01” for a door opened normally, code “02” for forced entry, and code “00” for a secure closed state). Motion sensors 102 may monitor movement within specific areas (e.g., using passive infrared (PIR) technology) to identify potential intrusions. Distinct codes based on activity may be used (e.g., code “01” for detected motion, code “02” for rapid movement, and code “00” for inactivity or no motion). Glass break sensors 112 may be installed near windows or glass doors, and may be configured to detect the sound or vibration of shattering glass and generate outputs accordingly (e.g., code “01” for glass break detected, code “00” for sensor fault). Smoke/carbon monoxide detectors 114 monitors for smoke and/or carbon monoxide (CO) levels, and may be installed in high-risk areas, such as kitchens, bedrooms, and hallways, and output specific codes depending on the type of hazard detected (e.g., code “01” for detecting smoke or CO, code “02” for low battery, and code “00” for fault condition). Smart locks 104 may be used at entry points to control entry, detect unauthorized access attempts, and issue outputs to indicate different events (e.g., code “01” for authorized entry, code “00” for unauthorized attempt). In some embodiments, the smart locks may log entries using authorized credentials, such as passcodes, fingerprints, facial recognition, key cards, or mobile app signals.

The depicted event-based sensors 105 are provided for conceptual clarity. In some embodiments, event-based (or triggered-driven) devices may also include other sensors related to access control, occupancy sensing, and/or monitoring hazardous indoor conditions, where these devices/sensors generate corresponding signals with event code in response to specific triggering events or threshold conditions. These devices may be incorporated as part of the broad security system 100.

The output data collected from these event-based sensors 105 (also referred to in some embodiments as trigger-driven, signal-triggered, or input-responsive sensors) may be referred to as event-based data (or trigger-based data). The data may include time-stamped detection signals, sensor identifiers, and event code that indicate the type and nature of the detected event. The output may be binary (e.g., “0” for no event and “1” for event detected) or multi-valued using discrete codes that classify specific scenarios.

As illustrated, the laser-based devices 110 (also referred to in some embodiments as LiDAR-based devices) includes perimeter LiDAR sensors 116, LiDAR motion detectors 118, and three-dimensional (3D) mapping LiDAR units 122. These devices use laser-based technology for advanced monitoring. For example, in some embodiments, the perimeter LiDAR sensors 116 may be installed along property lines and/or near entry points to create virtual boundaries and detect intruders. The LiDAR motion detectors 118 may be placed in indoor or outdoor spaces to detect movement. 3D Mapping LiDAR units 122 may be used to create spatial maps of the monitored environment. These maps may then be used by the LiDAR motion detectors or other types of sensors to identify changes or usually activities in real time. The depicted laser-based devices 110 are provided for conceptual clarity. In some embodiments, other devices that utilize laser-based technology for monitoring and detection may be used in the security system 100.

The data collected from these laser-based device 110 may be referred to as laser-based data. As used herein, laser-based data includes measurement outputs derived from laser ranging, scanning, or reflection techniques (e.g., time-of-flight (ToF)).

As depicted, the image-based devices 120 include security cameras 124, doorbell cameras 126, and thermal cameras 128. The image-based devices 120 rely on visual data (e.g., captured by security cameras or doorbell cameras) or infrared data (e.g., detected by thermal cameras) to monitor and analyze activities. In some embodiments, security cameras 124 may be installed indoors (e.g., hallways or living rooms) or outdoors (e.g., doors, windows, garages) to monitor for movement or unusual activity. Doorbell cameras 126 may be installed at entry points (e.g., front door) and capture video of visitors. Thermal cameras 128 detect heat signatures and may be used to monitor for movement or presence in low-visibility conditions. The depicted image-based devices 120 are provided for conceptual clarity. In some embodiments, other image-based devices that monitor environment using visual data may be included in the security system 100 as needed.

The data collected from these image-based device 120 may be referred to as image-based data. As used herein, image-based data may include any visual or thermal information captured by devices such as security cameras, doorbell cameras, and thermal imaging sensors. The data may take the form of still images, video frames, or pixel-based heat maps. The data may include metadata such as timestamps, camera identifiers, frame rates, resolution, or motion detection flags.

As shown, the RF-based devices 125 include Wi-Fi access points (APs) 134, Bluetooth beacons 136, and RF signature detectors 138. These devices monitor RF signals to identify nearby electronic devices and/or detect anomalies. In some embodiments, the Wi-Fi APs 134 may detect nearby devices based on Wi-Fi probe requests and use the information to identify devices entering their range. In some embodiments, the Bluetooth beacons 136 may detect Bluetooth-enabled devices in their vicinity by broadcasting signals and measuring the signal strength of received responses. In some embodiments, the RF signature detectors 138 may refer to devices that detect and analyze the unique RF signatures emitted by electronic devices to verify their presence, location, and/or identity. RF signatures may include signal strength, frequency patterns, modulation characteristics, or device-specific identifiers that distinguish one device from another.

The data collected from these RF-based devices may be referred to as RF-based data. As used herein, RF-based data includes information derived from the monitoring, transmission, or reception of radio frequency signals. The data may include signal strength indicators (RSSI), frequency usage patterns, timing data (e.g., timestamps of probe requests), and device identifiers (e.g., media access control (MAC) address or custom RF fingerprint).

As depicted, the security system further includes a security hub 130. In some embodiments, the security hub 130 may correspond to an edge device installed in the specific location being monitored. As shown, the security hub 130 includes four specialized software components (or programming instructions), each configured to aggregate and preprocess data collected from a respective suite of sensors and/or devices. These software components include an event-based signal processing component 140 (also referred to in some embodiments as trigger-driven signal processing component), an image processing component 145, a LiDAR-based signal processing component 150, and a RF-based signal processing component 155. The security hub 130 also features a keypad 132 on top for user authorization, which enables manual control and secure access to the security system.

In some embodiments, the event-based signal processing component 140 may aggregate binary and/or event-driven data from the event-based sensors 105 (e.g., door entrance alarms 108, window entrance alarms 106, motion sensors 102, glass break sensors 112, smoke/carbon monoxide detectors 114, and smart door locks 104) (also referred to in some embodiments as trigger-driven sensors). Following aggregation, the event-based signal processing component 140 may process the data by removing redundant events and formatting the for further ML analysis.

In some embodiments, the image-based signal processing component 145 may collect visual data from the image-based devices 120 (e.g., security cameras 124, doorbell cameras 126, and thermal cameras 128). Once collected, the image-based signal processing component 145 may then perform initial filtering, such as ignoring irrelevant frames or focusing on regions of interest (e.g., doorways or entry points), and preprocess the visual inputs for subsequent ML analysis (e.g., motion/object detection). In some embodiments, the preprocessing operations may include image resizing and cropping, noise reduction, and brightness and/or contrast corrections.

In some embodiments, the LiDAR-based (or laser-based) signal processing component 150 may aggregate spatial data from LiDAR sensors 110 (e.g., perimeter sensors 116, motion detectors 118, and 3D mapping units 122). After aggregation, the LiDAR-based signal processing component 150 may process the spatial information by standardizing distance measurements, removing noise (e.g., false reflections), and/or mapping the data into usable formats (e.g., occupancy grids) for further analysis (e.g., motion/object detection).

In some embodiments, the RF-based signal processing component 155 may collect RF data from the Wi-Fi APs 134, Bluetooth beacons 136, and other RF signature detectors 138. The RF data may then be used to identify the presence of unauthorized devices or disruptions within the vicinity. By monitoring RF signals in real time, the component 155 may improve the system's ability to detect potential security threats that are not visible to traditional sensors. Following the data collection and aggregation, the RF-based signal processing component 155 may preprocess signal data, such as by filtering out irrelevant or weak signals (e.g., distant or intermittent transmissions) and grouping RF events by device or location. The component 155 may then extract device signatures (e.g., media access control (MAC) addresses, signal strength patterns, or communication protocols) to identify familiar devices (e.g., smart phones, smart home devices) and flag unfamiliar (or potential unauthorized) devices within the range.

As depicted, the security hub 130 is connected to a server 135 (e.g., which may be local or remote). The connection between the security hub 130 and the server 135 may be established through wired cables (e.g., Ethernet cables), wireless protocols (e.g., Wi-Fi, Bluetooth, or other communication protocols), or a combination of wired and wireless links. The server 135 may or may not be limited to a single computing device or system. In some embodiments, the server 135 may be implemented as a distributed system that uses multiple interconnected computing devices for improved processing speed and efficiency.

In some embodiments, the server 135 may receive preprocessed data from the security hub 130 and analyze the data to determine whether an alarm is raised and, if so, whether the alarm is accurate. To achieve this, the server 135 may include separate software components (or programming instructions) configured for each type of detection system and for the overall false alarm classification process. More specifically, the server 135 may include an event-based fault detection component (also referred to in some embodiments as trigger-driven fault detection component), an image-based fault detection component, a LiDAR-based fault detection component, and a RF-based fault detection component. Each of these components processes the data received from its respective category of sensors (e.g., the LiDAR-based fault detection component receives data from LiDAR sensors 110), and independently classifies events into one category of a set of categories, such as a negative category (e.g., represented by “−1”) indicating the system or reporting sensor is malfunctioning (e.g., resulting in a false alarm); a neural category (e.g., represented by “0”), indicating a properly-functioning system with no alarm raised; or a positive category (e.g., represented by “1”), indicating a valid alarm triggered by a properly functioning system.

In some embodiments, these classifications may be performed using ML models trained on historical data. These models learn patterns from labeled examples of faulty alarms, valid alarms, and no alarms, and fine-tune their configurations to improve the accuracy and adaption to specific environmental conditions. The server 135 may further include a false alarm classification component. After the individual fault detection components generate their outputs, the false alarm classification component aggregates these outputs to produce a final classification. This final classification may be binary (e.g., false alarm or valid alarm), or represented on a likelihood scale (e.g., “very likely,” “likely,” “unlikely,” or “cannot say”). The final classification may then be transmitted back to the security hub 130, which determines whether to suppress the alarm (if the alarm is determined to be false) or trigger a security response (if the alarm is identified as valid). The disclosed security system 100 utilizes the integrated approach to improve reliability and efficiency, minimizing (or at least reducing) unnecessary disruptions while maintaining robust and accurate detection of security threats.

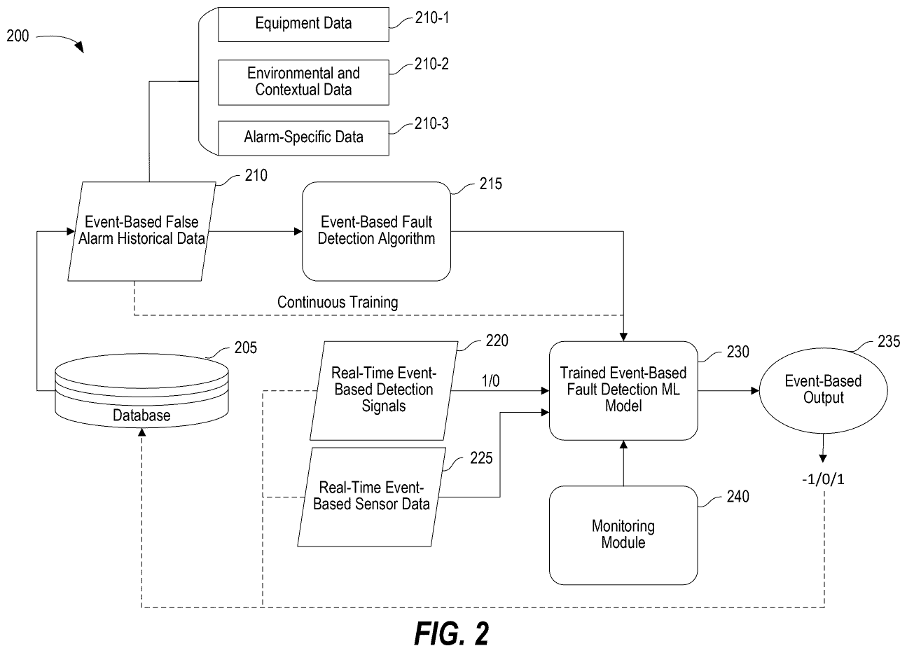

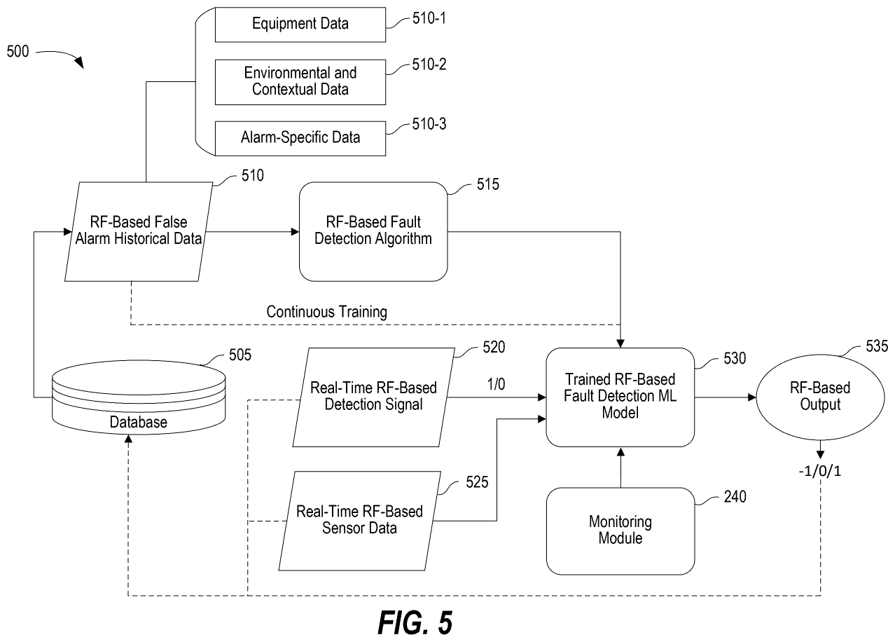

Further details about the ML training and interference processes for the four individual fault detection components are discussed below with references to FIGS. 2-5. Also, more information about the false alarm classification component, including the aggregation of outputs and the generation of final classifications, is discussed below with reference to FIG. 5.

The four types of sensors or devices—the event-based devices 105 (also referred to in some embodiments as trigger-driven or input-responsive devices), LiDAR-based devices 110, image-based devices 120, and RF-based devices 125, as depicted in FIG. 1—are provided for conceptual clarity. The disclosed security system 100 may be designed to be flexible and adaptable. In some embodiments, the security system 100 may include devices from only one category, such as the event-based devices (also referred to in some embodiments as trigger-driven devices), or the security system 100 may integrate devices from two, three, or all four categories, depending on the specific requirements of the monitored environment. In some embodiments, the security system may include laser-based devices in combination with any two of the other three categories of devices—event-based (trigger-driven), image-based, or RF-based devices. In some embodiments, the security system may include laser-based devices and trigger-driven devices, along with one additional category selected from either image-based or RF-based devices.

Furthermore, in some embodiments, the system 100 may include devices that do not fall within the depicted categories (e.g., novel or specialized sensors that provide additional functionality). In such configurations, a data preprocessing component and a fault detection component may be added and/or customized to process and analyze the data generated by such devices or sensors.

FIG. 2 illustrates a workflow 200 for training machine learning (ML) models to generate event-based output and implementing the models for real-time predictions, according to some embodiments of the present disclosure.

As depicted, a database 205 provides event-based historical data 210 for ML training. The event-based historical data (also referred to in some embodiments as trigger-driven historical data) may be collected from event-based sensors or devices (e.g., 105 of FIG. 1) installed within the monitored environment (or similar environments). The historical data 210 includes three categories: equipment data 210-1, environmental and contextual data 210-2, and alarm-specific data 210-3.

In some embodiments, the equipment data 210-1 may include sensor equipment information that provides specifications about the sensors used, such as device models, firmware versions, and other hardware and/or software details. The equipment data 210-1 may also include sensor equipment heartbeat signals received from each sensor. The heartbeat signals indicate each sensor's operational health or performance over time.

In some embodiments, the environmental and contextual data 210-2 may include details like customer demographics (which describes user behaviors or characteristics that may influence alarm patterns), home digital twin data (which captures virtual representations of the monitored environment, including virtual layouts, floor plans, and sensor placements), and system usage information (which represents how the security system is used, including frequency of activation, sensitivity settings, and response times).

In some embodiments, the alarm-specific data 210-3 may provide details about historical false alarms, including triggering conditions or causes that led to erroneous detections.

In addition to providing the categorized features, the historical data 210 also links these features to labels such as faulty alarm or system (e.g., represented by “−1”), no alarm (e.g., represented by “0”), and valid alarm (e.g., represented by “1”). During model training, the event-based fault detection algorithm 215 (also referred to in some embodiments as trigger-driven fault detection algorithm) may learn patterns and relationships between the input features (e.g., extracted from the equipment data, environmental and contextual data, and alarm-specific data) and the labeled outputs. The algorithm 215 may iteratively adjust, update, refine, or otherwise modify its configurations (or parameters) to optimize the ability to associate (or correlate) predictions to the target outputs (e.g., the labels). For example, the algorithm 215 learns to identify combinations of sensor data and environmental factors that are most likely to produce valid alarms versus faulty ones. In some embodiments, a validation dataset may be used during the training process to ensure that the model 215 does not overfit the training data and remains generalized to unseen scenarios.

Various algorithms 215 may be used during the training process to develop the final event-based fault detection ML model 230 (also referred to in some embodiments as trigger-driven fault detection ML model). In some embodiments, supervised learning techniques, such as decision trees, random forests, and support vector machines (SVMs), may be used for analyzing the structured data and classifying events as negative (faulty systems), neural (no alarms), or positive (valid alarms). In other embodiments, neural networks may be used to capture more complex and non-linear patterns within the historical data 210. The choice of algorithms depends on the nature of the input data, the complexity of the classification task, and the computational resources available for training.

After training, the resulting trained event-based fault detection ML model 230 is deployed to analyze data received from event-based devices within the monitored environment in order to generate predictions in real time. As depicted, the real-time data includes detection signals 220 received from event-based sensors (or devices) (e.g., 105 of FIG. 1). These signals may include binary indicators, where “0” indicates no event is detected, and “1” indicates that an event, such as a door opening, is detected. Additionally, the real-time data includes sensor data 225 received from the relevant event-based devices. The sensor data 225 may include real-time information about the reporting sensor's specification and operational status, such as its device model, firmware version, and periodic heartbeat updates. In some embodiments, real-time environmental and contextual data, such as the user demographics, home digital twin data, and system usage information, and false alarm causes, may also be provided as additional inputs to the trained ML for event prediction.

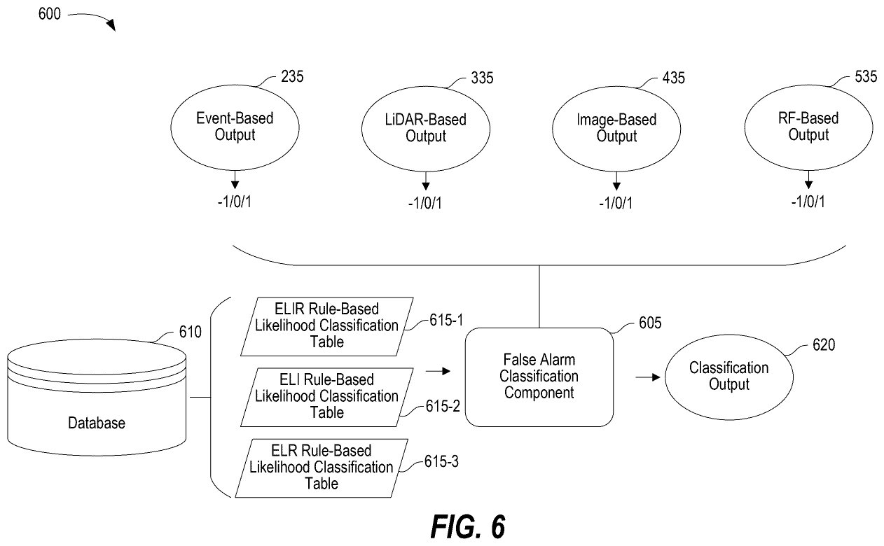

As illustrated, by processing the real-time input data 220 and 225, the trained model 230 generates an event-based output 235 (also referred to in some embodiments as trigger-driven output). The output classifies the detected event by the event-based system (or sensors) into three categories: negative (represented by “−1”), indicating the system or reporting sensor is faulty and generating a false alarm; neutral (represented by “0”), indicating no alarm and the system or reporting sensor is properly functioning; or positive (represented by “1”), indicating a valid alarm triggered by a properly-functioning system or reporting sensor. In some embodiments, the model 230 may generate a probability score for each classification category, representing the likelihood of the event falling into that category. Threshold values may then be applied to refine these probabilities into one of the multi-class categories. The output is then provided to a false alarm classification system (e.g., 605 of FIG. 6), which integrates outputs from other fault detection systems (or sensors) and performs further analysis to classify the overall likelihood of the alarm being a false alarm or a valid security event.

To ensure the event-based fault detection model 230 remain accurate and effective over time, in some embodiments, a continuous training process may be implemented. In this process, the event-based output 235 generated by the model is verified for correctness, which involves comparing the model's classification (e.g., negative, neutral, or positive) with the actual outcome of the detected event. For example, if the model classifies an event as a valid alarm (positive), the system verifies whether the alarm was indeed triggered by a legitimate security event.

Once verified, the event-based output 235, along with the corresponding real-time detection signals 220 and sensor data 225, is stored back into the database 205 as new training data. The updated dataset includes both the original historical data and newly collected data, and may then be used to retain the model 230. The retraining enables the model to adapt to changing environmental conditions, new sensor types, or updated operational parameters.

As depicted, a monitoring module 240 is coupled to the trained model 230. The monitoring module 240 may oversee the model's performance and determine when retraining or updates are required. Various metrics may be used by the monitoring module 240 to evaluate the model's performance, including, but not limited to, classification accuracy, false positive and false negative rates, and system response time.

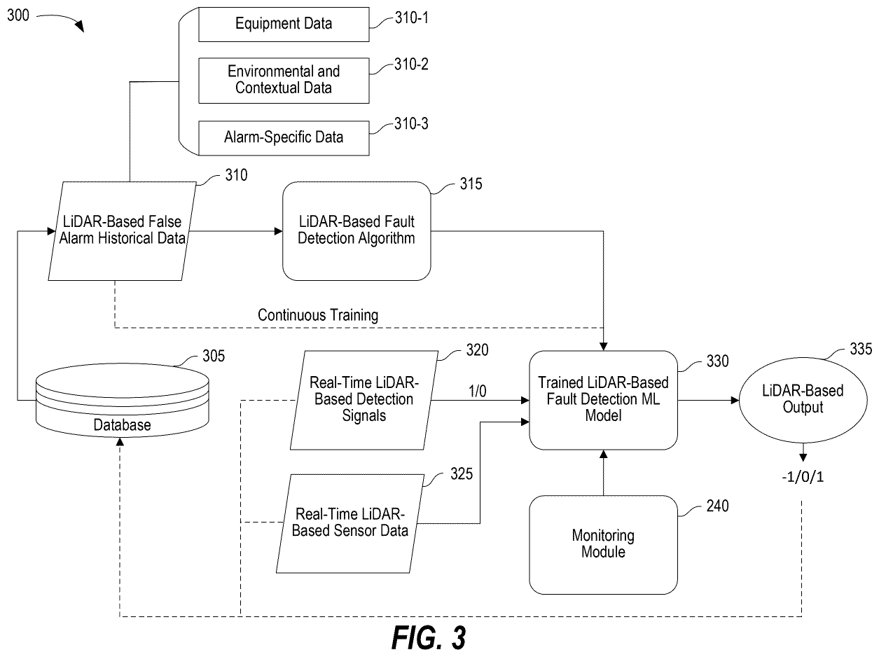

FIG. 3 illustrates a workflow 300 for training ML models to generate LiDAR-based output and implementing the models for real-time predictions, according to some embodiments of the present disclosure. The workflow 300 for training and deploying the LiDAR-based ML model (also referred to in some embodiments as laser-based ML model) follows a process similar to that described for the event-based ML model, as depicted in FIG. 2.

As depicted, a database 305 provides historical data 310 collected from LiDAR-based devices or sensors installed in the monitored environment (or similar environments). In some embodiments, the database 305 may be different from the database 205 as depicted in FIG. 2, which provides historical data collected from the event-based sensors. In some embodiments, a centralized database may provide historical data for all fault detection systems, including the LiDAR-based fault detection system.

As depicted, the historical data 310 for LiDAR-based devices (e.g., 110 of FIG. 1) includes three categories: equipment data 310-1, environmental and contextual data 310-2, and alarm-specific data 310-3. The equipment data 310-1 may include information about the LiDAR sensors, such as their specifications, device models, firmware versions, and operational heartbeat signals. The environmental and contextual data 310-2 may provide information about the spatial characteristics and/or virtual representations of the monitored environment, including home digital twin data, system usage data, and/or customer demographics. The alarm-specific data 310-3 may include details of past alarm events, including the cause of false alarms and triggering conditions.

Using the historical data 310, the LiDAR-based ML fault detection algorithm 315 is trained to learn correlations between the input features and the associated labels, such as faulty system, no alarm, and valid alarm. The training process involves fine-tuning the algorithm's 315 parameters to reduce predictions errors, such as by minimizing (or at least reducing) the differences between predicted and target outputs. As discussed above, various ML algorithms may be used, such as decision trees, random forests, and neural networks.

Once trained, the resulting trained LiDAR-based ML model 330 is deployed to process real-time data and generate LiDAR-based output 335. As depicted, the real-time data includes two types of input: LiDAR-based detection signals 320 and LiDAR-based sensor data 325. The detection signals 320 are received from LiDAR-based sensors (or devices) (e.g., 110 of FIG. 1) and include binary indicators, where “0” indicates that no event is detected, and “1” indicates that an event is detected (e.g., LiDAR motion detector detecting the motion of an object within the monitored area). The sensor data 325 may include real-time equipment data, such as the operational heartbeats and sensor specifications. In some embodiments, real-time environmental and contextual data, such as spatial configurations or customer-specific details, may also be provided to the trained ML model 330 as additional inputs.

By processing the real-time input data 320 and 325, the trained ML model 330 generates a LiDAR-based output 335, which classifies the detected event into one of three categories: −1, 0, and 1. In some embodiments, thresholds may be applied to the model's output probabilities to refine the classification process. As with the event-based system, the LiDAR-based output 335 is then provided to a false alarm classification system (e.g., 605 of FIG. 6), where it is integrated with outputs from other fault detection systems for further analysis.

In some embodiments, a continuous training process may be implemented to maintain the accuracy and efficiency of the trained LiDAR-based fault detection model 330 over time. This process involves verifying the LiDAR-based output 335 to confirm its accuracy. During verification, the system may evaluate whether the model's classification (e.g., −1, 0, 1) aligns with the actual event outcome.

After verification, the validated LiDAR-based output 335, along with the corresponding real-time detection signals 320 and sensor data 325, is fed back into the database 305 as additional training data. The updated dataset is then used to retrain the model 330. As depicted, a monitoring module 340 is integrated within the trained model 330 to track its performance and identify when updates or retraining are needed.

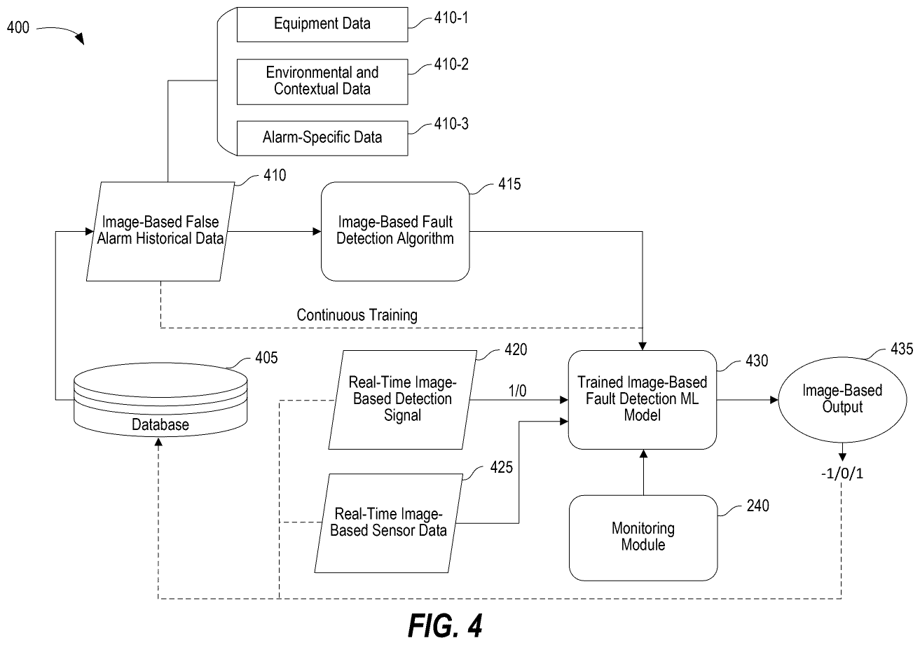

FIG. 4 illustrates a workflow 400 for training ML models to generate image-based output and implementing the models for real-time predictions, according to some embodiments of the present disclosure. The workflow 400 for training and deploying the image-based ML model follows a process similar to those described for the event-based ML model, as depicted in FIG. 2, and the LiDAR-based ML model, as depicted in FIG. 3.

As illustrated, a database 405 provides historical data 410 that is collected from image-based devices or sensors (e.g., 120 of FIG. 1), such as security cameras, doorbell cameras, and thermal cameras, installed in the monitored environment (or similar environments). In some embodiments, the database 405 may be different from the database 205 (as depicted in FIG. 2) or database 305 (as depicted in FIG. 3), which provides historical data collected from event-based devices or LiDAR-based devices, respectively. In some embodiments, a centralized database may provide historical data for multiple detection systems, including the image-based fault detection system.

As depicted, the historical data 410 for image-based devices includes three categories: equipment data 410-1, environmental and contextual data 410-2, and alarm-specific data 410-3. The equipment data 410-1 may include details about the image-based devices and cameras (e.g., device models, firmware versions, and other hardware and/or software details) and operational health indicators (e.g., periodic status signals or heartbeat). The environmental and contextual data 410-2 may provide information about the monitored area (e.g., home digital twin data), system usage patterns (e.g., system usage records), and customer-specific configurations (e.g., customer demographic data). The alarm-specific data 410-3 may include details of past alarm events, such as the conditions and/or causes that led to false alarms.

With the historical data 410, the image-based ML algorithm 415 is trained to learn patterns that correlate input features to specific labeled outputs, such as faulty system, no alarm, or valid alarm. During this training process, the algorithm 415 iteratively adjusts its parameters to minimize (or at least reduce) prediction errors and improve its classification accuracy. In some embodiments, convolutional neural networks (CNNs) may be used to analyze visual input data and detect objects, movements, or anomalies within the monitored environment. In some embodiments, a validation dataset may be used during the training process to prevent overfitting issue.

After the training is complete, the trained image-based fault detection ML model 430 is deployed to analyze real-time data and generate image-based output 435. As depicted, the real-time data include image-based detection signals 420, where “0” indicates no event has been detected, and “1” indicates that an event has been captured by the image-based device (e.g., security camera). Additionally, the real-time data also includes sensor data 425, which provides equipment details of cameras and other image-based devices, including their operational status (e.g., heartbeat signals) and specifications (e.g., device models or firmware versions). In some embodiments, real-time environmental and contextual data, such as virtual representations of the monitored area (e.g., home digital twin data), system usage patterns, or customer demographic information, may also be incorporated into the analysis.

As depicted, the trained image-based fault detection model 430 analyzes the real-time inputs 420 and 425 and produces an image-based output 435. In some embodiments, the output 435 may be generated as a probability score, and thresholds may be applied to refine the probability into multi-class classifications. As depicted, the image-based output 435 classifies the detected event into one of three categories: −1 (indicating the system or reporting device is malfunctioning, resulting in a false alarm), 0 (indicating no alarm and the system or reporting device is properly functioning), and 1 (indicating a valid alarm triggered by a properly-functioning system or reporting device). The image-based output 435 is then provided to a false alarm classification system (e.g., 605 of FIG. 6), which combines it with outputs from other detection systems to determine the overall likelihood of the alarm being false or valid.

Similar to the event-based fault detection model and LiDAR-based fault detection model, a continuous training process may be implemented to adapt the image-based model 430 to evolving conditions. In this process, the real-time input data (including detection signals 420 and sensor data 425) and the corresponding image-based output 435 are stored in the database 405 along with their verification results. The expanded dataset may then be used to retrain the model 430, refining the model to adapt to changes like new sensor configurations, environmental shifts, or emerging operational requirements.

As depicted, a monitoring module 440 is coupled to the trained model 430 to oversee the model's performance in real time. This module 440 may track performance metrics like classification accuracy, false positive and false negative rates, and system response time, and identify trends in misclassifications and flag scenarios where the model's predictions deviate from verified outcomes. When the monitoring module 440 detects a performance decline, it may trigger alerts and initiate the retraining process.

FIG. 5 illustrates a workflow 500 for training ML models to generate radio frequency (RF)-based output and implementing the models for real-time predictions, according to some embodiments of the present disclosure. The workflow 500 for training and deployment of the RF-based ML model follows a process similar to those described for the event-based ML model, as depicted in FIG. 2, the LiDAR-based ML model, as depicted in FIG. 3, and the image-based ML model, as depicted in FIG. 4.

Historical data 510 collected from RF sensors (e.g., 125 of FIG. 1), such as Wi-Fi APs (e.g., 134 of FIG. 1), Bluetooth Beacons (e.g., 136 of FIG. 1), and RF signature detector (e.g., 138 of FIG. 1), forms the foundation for training the model. As depicted, the historical data 510 is stored in the database 505, which may be different from those storing historical data for event-based, LiDAR-based, or image-based systems. In some embodiments, a centralized database may consolidate data across the fault detection systems for comprehensive training purposes.

As depicted, the historical data 510 includes three types of information: equipment data 510-1, environmental and contextual data 510-2, and alarm-specific data 510-3. In some embodiments, the equipment data 510-1 may provide the operational characteristics of RF sensors, such as the sensors'firmware versions, communication protocols, and signal heartbeat patterns that indicate device health. In some embodiments, the environmental and contextual data 510-2 may include information about the monitored area (e.g., home digital twin data), system usage patterns (e.g., system usage records), and customer-specific configurations (e.g., customer demographic data). In some embodiments, the alarm-specific data 510-3 may provide details of past alarm events, including instances where alarms were triggered and the causes of those alarms (e.g., valid or false).

Using the historical dataset 510, the RF-based fault detection algorithm 515 is trained to recognize patterns and relationships within the data. For example, the algorithm 515 learns to distinguish between RF signal disruptions caused by environmental factors and those caused by unauthorized activities. Supervised learning techniques, such as random forests, gradient boosting methods, or SVMs, may be used to analyze the structured RF data. In some embodiments, neural networks may be used to capture non-linear patterns within the historical data 510. The training process involves fine-tuning the algorithm 515 to minimize (or at least reduce) prediction errors and improve its accuracy to classify events into predefined categories.

Once trained, the RF-based ML model 530 is deployed for real-time predictions. The real-time data processed by the model 530 includes two inputs: detection signals 520 and sensor data 525. The real-time detection signals 520 may be received from RF-based sensors (e.g., 125 of FIG. 1), indicating whether the sensors has identified activities, with “0” representing no activity and “1” representing that an event, such as the presence of a new or unauthorized device, has been detected. The sensor data 525 may include real-time information about equipment details, such as device models, firmware versions, and operational heartbeats. In some embodiments, environmental and contextual data, such as customer demographics, home digital twin data, system usage information, and frequency of device changes, may also be provided as inputs to the trained ML for event prediction.

The trained RF-based model 530 processes these inputs 520 and 525 to generate an RF-based output 535, which classifies the event into one of three categories: −1, 0 and 1. The negative output represented by “−1” indicates the system or reporting device is faulty and generating a false alarm. The neural output represented by “0” indicates no alarm and the system or reporting device is properly functioning. The positive output represented by “1” indicates a valid alarm triggered by a properly-functioning system or reporting device. In some embodiments, the model may output a probability score for each category, and thresholds may be applied to refine the final classification into the appropriate category.

The resulting RF-based output 535 is then sent to a false alarm classification system (e.g., 605 of FIG. 6), where it is combined with outputs from other fault detection systems to determine the overall likelihood of the alarm being false or valid.

Similar to other detection models (e.g., the event-based fault detection model 230 as depicted in FIG. 2, the LiDAR-based fault detection model 330 as depicted in FIG. 3, the image-based fault detection model 430 as depicted in FIG. 4), a continuous training process may be implemented to ensure the RF-based model 530 remains accurate and effective over time. In this process, the real-time input data (including real-time detection signals 520 and sensor data 525) and the corresponding RF-based outputs 535 are stored in the database 505 along with their verification results. The updated dataset may then be used to retrain the ML model 530, refining the model 530 to adapt to evolving RF signal patterns.

As depicted, a monitoring module 540 is integrated with the trained model 530 to track the model's performance and identify when updates or retraining are needed. When performance degradation is detected, the monitoring module 540 may trigger alerts and initiate retraining.

FIG. 6 illustrates a workflow 600 for false alarm classification using outputs from event-based, laser-based, image-based, and RF-based systems, according to some embodiments of the present disclosure.

As illustrated, the false alarm classification component 605 receives outputs generated independently by each fault detection system. These outputs includes the event-based output 235, LiDAR-based output 335, image-based output 435, and RF-based output 535, which are received as real-time classifications (e.g., into categories represented by values such as −1, 0, or 1) from their respective trained ML models.

To determine the likelihood of a false alarm, the false alarm classification component 605 accesses a database 610 to retrieve a predefined rule-based likelihood classification table 615. The database 610 may be different from the databases 205, 305, 405, and 505, as depicted in FIGS. 2-5, which stores historical data for the event-based, LiDAR-based, image-based, and RF-based fault detection systems, respectively. In some embodiments, a centralized database may be used to include both the historical training data for the fault detection systems and the rule-based tables used by the classification system.

In some embodiments, the rule-based likelihood classification table 615 may define specific patterns of outputs across the fault detection systems and map these outputs to likelihood classifications. The false alarm classification component 605 may compare the received outputs with the entries in the predefined table to generate a final classification. Depending on the system configuration, the classification output may be binary (e.g., “0” representing a false alarm and “1” representing a valid alarm) or on a likelihood scale (e.g., expressed as “very likely,” “likely,” “unlikely,” and “cannot say”).

The rule-based likelihood classification table 615 may vary depending on the detection systems involved. In some embodiments, the system may use an ELIR-based table 615-1 to determine whether the alarm is false or valid. As used herein, the ELIR-based table refers to a table that includes outputs from all four fault detection systems (e.g., event-based, LiDAR-based, image-based, and RF-based systems). Each combination of outputs from these systems is mapped to a predictive classification, which may be represented as a binary indicator (e.g., “0” for a false alarm and “1” for a valid alarm) or expressed on a likelihood scale (e.g., “very likely a false alarm,” “likely a false alarm,” “unlikely a false alarm,” and “cannot say”). For example, the combination (1, 0, 0, 0) (where the event-based fault detection system outputs 1, while the LiDAR-based, image-based, and RF-based fault detection system output 0) may correspond to “very likely a false alarm,” indicating a situation where only one system identifies an issue while the others detect no activity. In contrast, the combination (1, 1, 1, 1) (where all four systems output 1) may correspond to “very unlikely a false alarm,” suggesting strong agreement across all detection systems and indicating a high likelihood of a valid alarm.

In some embodiments, the table may be specific to subsets of fault detection systems, such as an ELI-based table 615-2. As used herein, the ELI-based table 615-2 refers to a table that includes outputs from the event-based, LiDAR-based, and image-based systems, excluding from the RF-based system. Each combination of outputs from these three systems is mapped to a predictive classification, which may be represented as a binary indicator (e.g., “0” for a false alarm and “1” for a valid alarm) or expressed on a likelihood scale (e.g., “very likely a false alarm,” “likely a false alarm,” “unlikely a false alarm,” and “cannot say”). For example, the combination (1, 0, 0) (where the event-based fault detection system outputs 1, while the LiDAR-based and image-based fault detection system output 0) may correspond to “likely a false alarm,” while the combination (1, 1, 1) (where all three system output 1) may correspond to “unlikely a false alarm.”

In some embodiments, a ELR-based table 615-3 may be used. As used herein, the ELR-based table refers to a table that includes outputs from the event-based, LiDAR-based, and RF-based systems. Each combination of outputs from these three systems is mapped to a predictive classification. For example, a combination (1, 0, 0) (where the event-based fault detection system outputs 1, while the LiDAR-based and RF-based fault detection system output 0) may correspond to “likely a false alarm,” while the combination (1, 1, 1) (where all three systems output 1) may correspond to “unlikely a false alarm.”

Once the comparison is completed, the false alarm component 605 generates an aggregate output, indicating the likelihood that the alarm is false or valid. The output may then be provided to an edge device (e.g., the security hub 130 of FIG. 1) installed within the monitored environment. The security hub may then use the classification results to determine whether to suppress the alarm or initiate a security response (e.g., notifying homeowners or triggering emergency protocols).

The illustrated four fault detection systems, as shown in FIGS. 2-6, are provided for conceptual clarity. In some embodiments, other detection systems may also be included, depending on the specific sensors (or devices) used in the monitored environment. Additionally, one or more of the depicted fault detection systems may be omitted, allowing for a simplified configuration adjusted to specific needs.

The illustrated rule-based likelihood classification tables 615 are provided for conceptual clarity. In some embodiments, alternative classification tables that include additional outputs or omit some of the depicted outputs may be used.

In some embodiments, the rule-based table 615 may be dynamically updated based on real-time system performance. For example, as the system operates over time, feedback on the accuracy of classifications, such as whether alarms flagged as valid were genuinely valid or whether false alarms were correctly identified, may be used to refine the table.

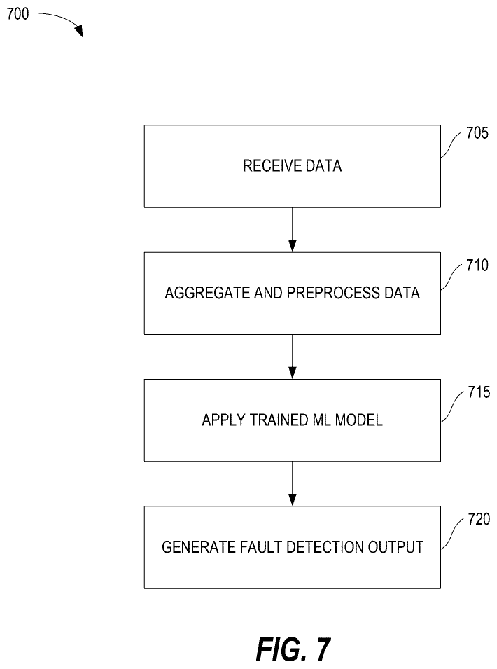

FIG. 7 depicts an example method 700 for processing sensor data to generate fault detection outputs using trained ML models, according to some embodiments of the present disclosure. In some embodiments, the depicted example method 700 may be implemented by one or more computing devices or systems configured to perform event-based, LiDAR-based, image-based, or RF-based fault detections. Each individual fault detection system operates independently to analyze sensor data and generate outputs.

At block 705, a fault detection system receives real-time data from its respective sensors or devices. The data may include detection signals (e.g., 0 or 1) and additional contextual or operational information. For example, a LiDAR-based fault detection system may receive real-time detection signals (e.g., 320 of FIG. 3) from LiDAR sensors (e.g., 110 of FIG. 1), as well as information related to the LiDAR sensor's equipment details (e.g., specifications and firmware versions), operational status (e.g., heartbeat signals), and other contextual or environmental data (e.g., system usage patterns, home digital twin data, and customer demographics). Other fault detection systems, such as event-based, image-base, and RF-based systems, may follow a similar process, receiving data specific to their respective devices or sensors.

At block 710, the fault detection system aggregates and preprocesses the received data to standardize it and filter out noise or irrelevant information. The preprocessing operation is to ensure the data is clean and suitable for analysis by the ML models. For example, the LiDAR-based fault detection system may aggregate data received from LiDAR sensors within the monitored environment. The LiDAR-based fault detection system may then preprocess the data by removing noise caused by environmental interferences, such as reflections or overlapping signals from nearby objects, and normalizing spatial data for consistency. The event-based, image-based, and RF-based fault detection systems may preprocess their respective data similarly, addressing issues like redundant signals, image distortion, or inconsistent RF patterns.

At block 715, the fault detection system analyzes the data using trained ML models. The model, trained on historical data, analyzes the input data to detect patterns and relationships and identify faulty systems, valid alarms, or normal systems with no alarm. In some embodiments, the operations of collecting and preprocessing sensor data (as depicted at blocks 705 and 710), as well as analyzing the data using trained ML models (as depicted at block 715) may be activated when at least one sensor (or device) (whether event-based, image-based, LiDAR-based, or RF-based) provides a detection signal of “1,” indicating that an alarm has been triggered. Once activated, each independent fault detection system may collect and preprocess data received from its respective sensors (including sensors other that the one reporting the triggered alarm), and generate corresponding outputs. This selective approach allows efficient utilization of computational resources, as the analysis is only triggered when an actual alarm condition is detected rather than running continuously for all circumstances.

At block 720, the fault detection system generates an output classifying the detection signals or events. For example, the LiDAR-based fault detection system may input the received detection signals (e.g., 0 or 1) and equipment information for LiDAR sensors into the trained model to generate a LiDAR-based output (e.g., 335 of FIG. 3). In some embodiments, the output may categorize the detection signals into three categories: −1, 0 and 1. The negative output represented by “−1” indicates the system or reporting device is faulty, resulting in a false alarm. The neutral output represented by “0” indicates no alarm and the system or reporting device is properly functioning. The positive output represented by “1” indicates a valid alarm triggered by a properly-functioning system or reporting device. Other systems, including event-based, image-based, and RF-based fault detection systems, follow a similar process and generate outputs aligned with their specific data inputs.

In some embodiments, the output, along with its verification results and corresponding input data (e.g., detection signals, sensor data, and any additional contextual inputs), may be collected and stored as new training data to update the model. This process involves validating the output (e.g., −1, 0, 1) by comparing it to the actual event outcome. Once verified, the combined data is integrated into the existing dataset for continuous retraining. In some embodiments, the decision to initiate retraining may be guided by a monitoring module (e.g., 240 of FIG. 2), which oversees and tracks the model's performance (using metrics like classification accuracy, false positive rate, false negative rate, and system response time).

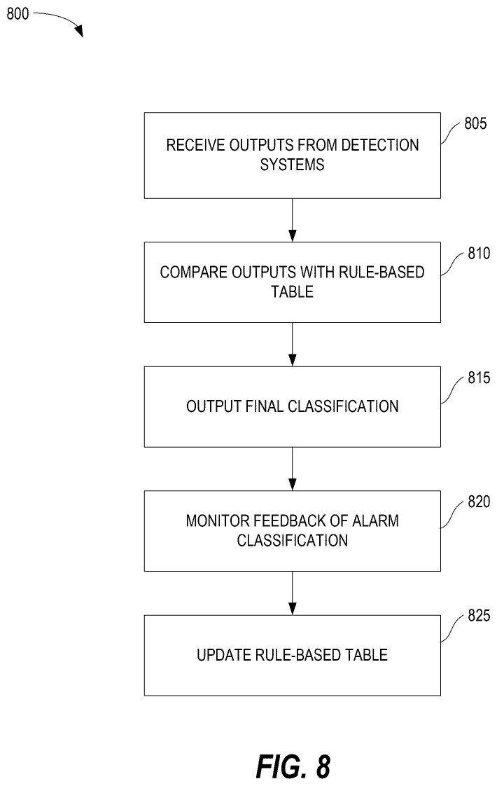

FIG. 8 depicts an example method 800 for processing fault detection outputs to generate a final false alarm classification, according to some embodiments of the present disclosure. In some embodiments, the depicted example method 800 may be implemented by one or more computing devices or systems configured to perform alarm classification based on outputs received from multiple fault detection systems, including event-based, LiDAR-based, image-based, or RF-based fault detection systems.

At block 805, a false alarm classification system receives real-time outputs from multiple fault detection systems, such as event-based, LiDAR-based, image-based, and RF-based systems. These outputs, represented as classifications (e.g., −1, 0, or 1), are the results of independent analysis by their respective trained ML models.

At block 810, the false alarm classification system compares the received outputs against a predefined rule-based likelihood classification table (e.g., 615 of FIG. 6). This table maps specific combinations of outputs from the detection systems to corresponding classifications. In some embodiments, the classification may be binary, such as “false alarm” or “valid alarm.” In some embodiments, the classification may be expressed on a likelihood scale, such as “very likely,” “likely,” “unlikely,” or “cannot say.” The table may be configured to include ELIR-based combinations, ELI-based combinations, or ELR-based combinations.

At block 815, based on the comparison, the false alarm classification system generates a final classification that determines the likelihood of the alarm being false or valid. In some embodiments, the output may then be sent back to an edge device (e.g., the security hub 130 of FIG. 1). The edge device may suppress the alarm if it is classified as false or trigger a security response, such as notifying the homeowner or activating emergency protocols, if the alarm is classified as valid.

At block 820, the false alarm classification system monitors the feedback of the alarm classification and the subsequent actions taken. If the alarm is classified as false and therefore suppressed, the system checks if it was indeed a false alarm. If the alarm is classified as valid and therefore triggers a security response, the system determines whether a security threat indeed exists within the monitored environment.

At block 825, the false alarm classification system updates the rule-based tables based on the monitored feedback to improve the accuracy for future classifications. In some embodiments, the updates may include modifying thresholds, adding new combinations, or removing outdated entries to adapt to evolving conditions.

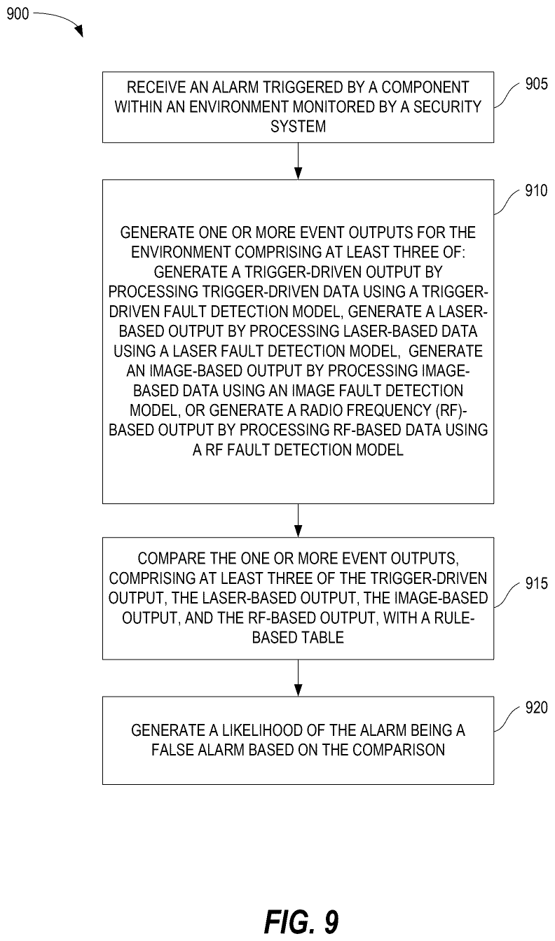

FIG. 9 is a flow diagram depicting an example method 900 for false alarm classification, according to some embodiments of the present disclosure.

At block 905, a computing system receives an alarm (e.g., 220 of FIG. 2, 320 of FIG. 3, 420 of FIG. 4, or 520 of FIG. 5) triggered by a component within an environment monitored by a security system.

At block 910, the computing system generates one or more event outputs for the environment comprising at least three of: generating a trigger-driven output (e.g., 235 of FIG. 2) by processing trigger-driven data using a trigger-driven fault detection model (e.g., 230 of FIG. 1), generating a laser-based output (e.g., 335 of FIG. 3) by processing laser-based data using a laser fault detection model (e.g., 330 of FIG. 3), generating an image-based output (e.g., 435 of FIG. 4) by processing image-based data using an image fault detection model (e.g., 430 of FIG. 4), or generating a radio frequency (RF)-based output (e.g., 535 of FIG. 5) by processing RF-based data using a RF fault detection model (e.g., 530 of FIG. 5).

At block 915, the computing system compares the one or more event outputs, comprising at least three of the trigger-driven output, the laser-based output, the image-based output, and the RF-based output, with a rule-based table (e.g., 615 of FIG. 6).

At block 920, the computing system generates a likelihood of the alarm being a false alarm (e.g., 620 of FIG. 6) based on the comparison.

In some embodiments, the computing system may further trigger a security response based on the likelihood of the alarm being a false alarm.

In some embodiments, the component may be selected from one or more trigger-driven sensors, one or more laser-based sensors, one or more cameras, and the one or more RF-based sensors.

In some embodiments, each of the trigger-driven output, the laser-based output, the image-based output, and the RF-based output may be selected from: an indicator representing the alarm is faulty and a respective trigger-driven sensor, laser-based sensor, camera, and RF-based sensor is malfunctioning, an indicator representing no alarm and the respective trigger-driven sensor, laser-based sensor, camera, or RF-based sensor is properly functioning, or an indicator representing the alarm is valid and the respective trigger-driven sensor, laser-based sensor, camera, or RF-based sensor is properly functioning.

In some embodiments, the rule-based table (e.g., 615-1 of FIG. 6) may define a plurality of alarm classifications based on a combination of the trigger-driven output, the laser-based output, the image-based output, and the RF-based output.

In some embodiments, the rule-based table (e.g., 615-2 of FIG. 6) may define a plurality of alarm classifications based on a combination of the trigger-driven output, the laser-based output, and the image-based output.

In some embodiments, the rule-based table (e.g., 615-3 of FIG. 6) may define a plurality of alarm classifications based on a combination of the trigger-driven output, the laser-based output, and the RF-based output.

In some embodiments, the trigger-driven fault detection model may be trained by collecting historical trigger-driven sensor data (e.g., 210 of FIG. 2) from the environment, allocating a label to the historical trigger-driven sensor data based on an output of a historical alarm, and training the trigger-driven fault detection model (e.g., 215 of FIG. 2) by using the historical trigger-driven sensor data as an input and the label as a target output, where the trigger-driven fault detection model learns to correlate the input to the target output. In some embodiments, the label may be selected from: an indicator representing the historical alarm is faulty and a respective trigger-driven sensor is malfunctioning, an indicator representing no alarm and the respective trigger-driven sensor is properly functioning, or an indicator representing the historical is valid and the respective trigger-driven sensor is properly functioning.

In some embodiments, the laser fault detection model is trained by collecting historical laser-based data (e.g., 310 of FIG. 3) from the environment, allocating a label to the historical laser-based data based on an output of a historical alarm, and training the laser-based fault detection model (e.g., 315 of FIG. 3) by using the historical laser-based data as an input and the label as a target output, where the laser-based fault detection model learns to correlate the input to the target output. In some embodiments, the label may be selected from: an indicator representing the historical alarm is faulty and a respective laser-based sensor is malfunctioning, an indicator representing no alarm and the respective laser-based sensor is properly functioning, or an indicator representing the historical is valid and the respective laser-based sensor is properly functioning.

In some embodiments, the image fault detection model may be trained by collecting historical image data (e.g., 410 of FIG. 4) from the environment, allocating a label to the historical image data based on an output of a historical alarm, and training the image fault detection model (e.g., 415 of FIG. 4) by using the historical image data as an input and the label as a target output, where the image fault detection model learns to correlate the input to the target output. In some embodiments, the label may be selected from: an indicator representing the historical alarm is faulty and a respective camera is malfunctioning, an indicator representing no alarm and the respective camera is properly functioning, or an indicator representing the historical alarm is valid and the respective camera is properly functioning.

In some embodiments, the RF fault detection model may be trained by collecting historical RF-based data (e.g., 510 of FIG. 5) from the environment, allocating a label to the historical RF-based data based on an output of a historical alarm, and training the RF fault detection model (e.g., 515 of FIG. 5) by using the historical RF-based data as an input and the label as a target output, where the RF fault detection model learns to correlate the input to the target output. In some embodiments, the label is selected from: an indicator representing the historical alarm is faulty and a respective RF-based sensor is malfunctioning, an indicator representing no alarm and the respective RF-based sensor is properly functioning, or an indicator representing the historical alarm is valid and the respective RF-based sensor is properly functioning.

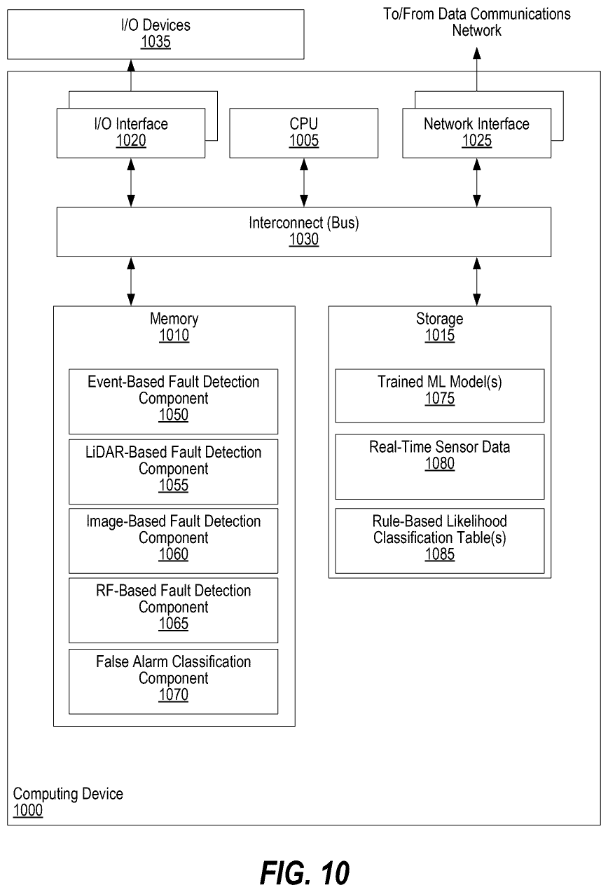

FIG. 10 depicts an example computing device 1000 configured to perform various aspects of the present disclosure, according to some embodiments of the present disclosure. In some embodiment, the computing device 1000 may correspond to the server 135 as depicted in FIG. 1. Although depicted as a physical device, in some embodiments, the computing device 1000 may be implemented using virtual device(s), and/or across a number of devices (e.g., in a cloud environment).

As illustrated, the computing device 1000 includes a CPU 1005, memory 1010, storage 1015, one or more network interfaces 1025, and one or more I/O interfaces 1020. In the illustrated embodiment, the CPU 1005 retrieves and executes programming instructions stored in memory 1010, as well as stores and retrieves application data residing in storage 1015. The CPU 1005 is generally representative of a single CPU and/or GPU, multiple CPUs and/or GPUs, a single CPU and/or GPU having multiple processing cores, and the like. The memory 1010 is generally considered to be representative of a random access memory. Storage 1015 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 1035 (such as keyboards, monitors, etc.) are connected via the I/O interface(s) 1020. Further, via the network interface 1025, the computing device 1000 can be communicatively coupled with one or more other devices and components (e.g., via a network, which may include the Internet, local network(s), and the like). As illustrated, the CPU 1005, memory 1010, storage 1015, network interface(s) 1025, and I/O interface(s) 1020 are communicatively coupled by one or more buses 1030.

In the illustrated embodiment, the memory 1010 includes an event-based fault detection component 1050 (also referred to in some embodiments as trigger-driven fault detection component), a LiDAR-based fault detection component 1055, an image-based fault detection component 1060, a RF-based fault detection component 1065, and a false alarm classification component 1070. Although depicted as discrete components for conceptual clarity, in some embodiments, the operations of the depicted components (and others not illustrated) may be combined or distributed across any number of components. Further, although depicted as software residing in memory 1010, in some embodiments, the operations of the depicted components (and others not illustrated) may be implemented using hardware, software, or a combination of hardware and software.

In one embodiment, the event-based fault detection component 1050 may analyze data collected from event-based sensors (e.g., 105 of FIG. 1) (or preprocessed data sent by the edge device, such as the security hub 130 of FIG. 1). The component 1050 may apply trained ML models to determine whether the system (or reporting sensor) is faulty (“−1”), whether the system (or sensor) is functioning correctly without detecting any security events (“0”), or whether the system (or sensor) is functioning with an alarm triggered (“1”).

In one embodiment, the LiDAR-based fault detection component 1055 may analyze data collected from LiDAR-based sensors (e.g., 110 of FIG. 1) (or preprocessed data sent by the edge device, such as the security hub 130 of FIG. 1). The component 1050 may apply trained ML models to determine whether the system (or reporting sensor) is faulty (“−1”), whether the system (or sensor) is functioning correctly without detecting any security events (“0”), or whether the system (or sensor) is functioning with an alarm triggered.

In one embodiment, the image-based fault detection component 1060 may analyze data collected from image-based devices (e.g., 120 of FIG. 1) (or preprocessed data sent by the edge device, such as the security hub 130 of FIG. 1). The component 1060 may apply trained ML models to classify events into faulty system (“−1”), valid alarm with properly-functioning system (“1”), or no alarm with properly-functioning system (“0”).

In one embodiment, the RF-based fault detection component 1065 may analyze data collected from RF-based devices (e.g., 125 of FIG. 1) (or preprocessed data sent by the edge device, such as the security hub 130 of FIG. 1). The component 1065 may apply trained ML models to classify events into faulty system (“−1”), valid alarm with properly-functioning system (“1”), or no alarm with properly-functioning system (“0”).

In some embodiments, the event-based fault detection component 1050, LiDAR-based fault detection component 1055, image-based fault detection component 1060, and RF-based fault detection component 1065 may each include a subcomponent or a collection of programming code designed to monitor the performance of their respective deployed fault detection ML models. When performance degradation is observed, such as a decline in classification accuracy or an increase in false positive or false negative rate, the subcomponents may initiate the retraining process. In the retraining process, real-time data, such as detection signals, sensor data, and other contextual inputs, may be collected and cross verified against actual event outcomes. The newly verified data may then be labeled, added to the existing dataset, and used for update the models through retraining.

In one embodiment, the false alarm classification component 1070 may integrate outputs received from the fault detection components. The false alarm classification component 1070 may then compare these outputs against a predefined rule-based likelihood classification table (e.g., 615 of FIG. 6) to determine the likelihood of the alarm being false or valid (e.g., 620 of FIG. 6).

In the illustrated example, the storage 1015 may include various types of data for effective operations of the computing device in fault detection and alarm classification. The data may include, but is not limited to, trained ML models 1075, real-time data collected from sensors or devices 1080, predefined rule-based likelihood classification tables 1085, and system logs and feedback data. In some embodiments, the aforementioned data may be saved in a remote database (e.g., 205 of FIG. 2, 305 of FIG. 3, 405 of FIG. 4, 505 of FIG. 5, or 605 of FIG. 6) that connects to the computing device 1000 via a network (e.g., the Internet). In some embodiments, the real-time sensor data, along with corresponding classification outputs and verification results, may be collected and stored in the storage 1015 or a remote database for continuous model retraining.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving an alarm triggered by a component within an environment monitored by a security system;
generating one or more event outputs for the environment comprising at least three of:
generating a trigger-driven output by processing trigger-driven data using a trigger-driven fault detection model,
generating a laser-based output by processing laser-based data using a laser fault detection model,
generating an image-based output by processing image-based data using an image fault detection model, or
generating a radio frequency (RF)-based output by processing RF-based data using a RF fault detection model;
comparing the one or more event outputs, comprising at least three of the trigger-driven output, the laser-based output, the image-based output, and the RF-based output, with a rule-based table; and
generating a likelihood of the alarm being a false alarm based on the comparison.

2. The method of claim 1, further comprising trigging a security response based on the likelihood of the alarm being a false alarm.

3. The method of claim 1, wherein the component is selected from one or more trigger-driven sensors, one or more laser-based sensors, one or more cameras, and one or more RF-based sensors.

4. The method of claim 1, wherein each of the trigger-driven output, the laser-based output, the image-based output, and the RF-based output is selected from:
an indicator representing the alarm is faulty and a respective trigger-driven sensor, laser-based sensor, camera, and RF-based sensor is malfunctioning,
an indicator representing no alarm and the respective trigger-driven sensor, laser-based sensor, camera, or RF-based sensor is properly functioning, or
an indicator representing the alarm is valid and the respective trigger-driven sensor, laser-based sensor, camera, or RF-based sensor is properly functioning.

5. The method of claim 1, wherein the rule-based table defines a plurality of alarm classifications based on a combination of the trigger-driven output, the laser-based output, the image-based output, and the RF-based output.

6. The method of claim 1, wherein the rule-based table defines a plurality of alarm classifications based on a combination of the trigger-driven output, the laser-based output, and the image-based output.

7. The method of claim 1, wherein the rule-based table defines a plurality of alarm classifications based on a combination of the trigger-driven output, the laser-based output, and the RF-based output.

8. The method of claim 1, wherein the trigger-driven fault detection model is trained by:
collecting historical trigger-driven sensor data from the environment;
allocating a label to the historical trigger-driven sensor data based on an output of a historical alarm, wherein the label is selected from:
an indicator representing the historical alarm is faulty and a respective trigger-driven sensor is malfunctioning,
an indicator representing no alarm and the respective trigger-driven sensor is properly functioning, or
an indicator representing the historical alarm is valid and the respective trigger-driven sensor is properly functioning; and
training the trigger-driven fault detection model by using the historical trigger-driven sensor data as an input and the label as a target output, wherein the trigger-driven fault detection model learns to correlate the input to the target output.

9. The method of claim 1, wherein the laser fault detection model is trained by:
collecting historical laser-based data from the environment;
allocating a label to the historical laser-based data based on an output of a historical alarm, wherein the label is selected from:
an indicator representing the historical alarm is faulty and a respective laser-based sensor is malfunctioning,
an indicator representing no alarm and the respective laser-based sensor is properly functioning, or
an indicator representing the historical is valid and the respective laser-based sensor is properly functioning; and
training the laser fault detection model by using the historical laser-based data as an input and the label as a target output, wherein the laser fault detection model learns to correlate the input to the target output.

10. The method of claim 1, wherein the image fault detection model is trained by:
collecting historical image data from the environment;
allocating a label to the historical image data based on an output of a historical alarm, wherein the label is selected from:
an indicator representing the historical alarm is faulty and a respective camera is malfunctioning,
an indicator representing no alarm and the respective camera is properly functioning, or
an indicator representing the historical alarm is valid and the respective camera is properly functioning; and
training the image fault detection model by using the historical image data as an input and the label as a target output, wherein the image fault detection model learns to correlate the input to the target output.

11. The method of claim 1, wherein the RF fault detection model is trained by:
collecting historical RF-based data from the environment;
allocating a label to the historical RF-based data based on an output of a historical alarm, wherein the label is selected from:
an indicator representing the historical alarm is faulty and a respective RF-based sensor is malfunctioning,
an indicator representing no alarm and the respective RF-based sensor is properly functioning, or
an indicator representing the historical alarm is valid and the respective RF-based sensor is properly functioning; and
training the RF fault detection model by using the historical RF-based data as an input and the label as a target output, wherein the RF fault detection model learns to correlate the input to the target output.

12. A system, comprising:
one or more memories collectively containing one or more programs; and
one or more processors, wherein the one or more processors are configured to, individually or collectively, perform an operation comprising:
receiving an alarm triggered by a component within an environment monitored by a security system;
generating one or more event outputs for the environment comprising at least three of:
generating a trigger-driven output by processing trigger-driven data using an trigger-driven fault detection model,
generating a laser-based output by processing laser-based data using a laser fault detection model,
generating an image-based output by processing image-based data using an image fault detection model, or
generating a radio frequency (RF)-based output by processing RF-based data using a RF fault detection model;
comparing the one or more event outputs, comprising at least three of the trigger-driven output, the laser-based output, the image-based output, and the RF-based output, with a rule-based table; and
generating a likelihood of the alarm being a false alarm based on the comparison.

13. The system of claim 12, wherein the operation further comprises trigging a security response based on the likelihood of the alarm being a false alarm.

14. The system of claim 12, wherein the component is selected from one or more trigger-driven sensors, one or more laser-based sensors, one or more cameras, and one or more RF-based sensors.

15. The system of claim 12, wherein each of the trigger-driven output, the laser-based output, the image-based output, and the RF-based output is selected from:
an indicator representing the alarm is faulty and a respective trigger-driven sensor, laser-based sensor, camera, and RF-based sensor is malfunctioning,
an indicator representing no alarm and the respective trigger-driven sensor, laser-based sensor, camera, or RF-based sensor is properly functioning, or
an indicator representing the alarm is valid and the respective trigger-driven sensor, laser-based sensor, camera, or RF-based sensor is properly functioning.

16. The system of claim 12, wherein the rule-based table defines a plurality of alarm classifications based on a combination of the trigger-driven output, the laser-based output, the image-based output, and the RF-based output.

17. The system of claim 12, wherein the rule-based table defines a plurality of alarm classifications based on a combination of the trigger-driven output, the laser-based output, and the image-based output.

18. The system of claim 12, wherein the rule-based table defines a plurality of alarm classifications based on a combination of the trigger-driven output, the laser-based output, and the RF-based output.

19. The system of claim 12, wherein the trigger-driven fault detection model is trained by:
collecting historical trigger-driven sensor data from the environment;
allocating a label to the historical trigger-driven sensor data based on an output of a historical alarm, the label is selected from:
an indicator representing the historical alarm is faulty and a respective trigger-driven sensor is malfunctioning,
an indicator representing no alarm and the respective trigger-driven sensor is properly functioning, or
an indicator representing the historical alarm is valid and the respective trigger-driven sensor is properly functioning; and
training the trigger-driven fault detection model by using the historical trigger-driven sensor data as an input and the label as a target output, wherein the trigger-driven fault detection model learns to correlate the input to the target output.

20. One or more non-transitory computer-readable media containing, in any combination, computer program code that, when executed by operation of a computer system, performs operations comprising:
receiving an alarm triggered by a component within an environment monitored by a security system;
generating one or more event outputs for the environment comprising at least three of:
generating a trigger-driven output by processing trigger-driven data using an trigger-driven fault detection model,
generating a laser-based output by processing laser-based data using a laser fault detection model,
generating an image-based output by processing image-based data using an image fault detection model, or
generating a radio frequency (RF)-based output by processing RF-based data using a RF fault detection model;
comparing the one or more event outputs, comprising at least three of the trigger-driven output, the laser-based output, the image-based output, and the RF-based output, with a rule-based table; and
generating a likelihood of the alarm being a false alarm based on the comparison.
